(19) United States
(12) Patent Application Publication
(10) Pub. No.: US 2015/0283584 A1
(43) Pub. Date: Oct. 8, 2015

(54) CLEANING POCKETS ON INDENT CYLINDERS

(71) Applicant: Jack Valleau, Ridgedale (CA)

(72) Inventor: Jack Valleau, Ridgedale (CA)

(21) Appl. No.: 14/675,182

(22) Filed: Mar. 31, 2015

(30) Foreign Application Priority Data
Apr. 4, 2014 (CA) 2848293

(51) Int. Cl. B07B 11/08; B08B 5/02; B08B 1/00

(52) U.S. Cl. CPC B07B 11/08; B08B 1/001; B08B 5/02

(57) ABSTRACT

A cleaning apparatus removes material collected in pockets evenly space about an inner surface of an indent cylinder. The apparatus has a hub rotatably mounted on a shaft near a working end of the shaft. A plurality of spikes extend from a surface of the hub, and outer ends of the spikes are pointed and the spikes extend radially outward from a rotational axis of the hub substantially the same distance. The outer ends of the spikes are evenly spaced to correspond to a spacing of the pockets of the indent cylinder. The indent cylinder is rotated while pressing the hub toward the inner surface of the indent cylinder such that the pointed outer ends of the spikes enter the pockets as the indent cylinder rotates and dislodge the material from the pockets.

This disclosure relates to the field of indent cylinders such as are used to separate impurities from granular material, such as seeds of grain and like agricultural products, and in particular a cleaning apparatus for removing material that builds up in the pockets of the indent cylinders.

### BACKGROUND

An indent roller or cylinder is used in a granular material cleaning machine, notably a seed cleaning machine, to separate grain by kernel length. The cylinder itself is a thin-walled tube with indents, commonly referred to as pockets, formed on the inside to the shape of a hemisphere. The pockets are evenly spaced in rows along the inside surface of the cylinder and are sized to suit the particular material being separated. The seed kernels that fit into the pocket are lifted up and dropped into a collection trough that runs the entire length of the cylinder, while the longer kernels slide off and tail out the end. The speed that the cylinder turns creates friction and centrifugal force that hold the particle in the indent in place, and as the cylinder turns, that particle is lifted to a point where gravity takes over and allows the kernel to fall into the collection trough. By passing the product through a series of cylinders with different indent pocket sizes, fine separations of these products can be achieved.

Such a grain cleaning machine with indent cylinders is disclosed for example in U.S. Pat. No. 6,602,130 to Manning et al. A significant problem with cleaning some agricultural seeds, such as hemp, flax, and borage for example, is that oily particles of material may build up quite quickly in the pockets, and the seeds then no longer stay in the pockets to be lifted to the collection trough. The cleaning machine must then be disassembled to allow access to the interior of the indent cylinder to clean this built up material out of the pockets.

### SUMMARY OF THE INVENTION

The present disclosure provides an apparatus for removing built up material from the pockets of an indent cylinder that overcomes problems in the prior art.

In a first embodiment the present disclosure provides a cleaning apparatus for removing material collected in pockets evenly space about an inner surface of an indent cylinder. The apparatus comprises a hub rotatably mounted on a shaft near a working end of the shaft. A plurality of spikes extend from a surface of the hub, and the spikes extend radially outward from a rotational axis of the hub substantially the same distance. The outer ends of the spikes are evenly spaced to correspond to a spacing of the pockets of the indent cylinder.

In a second embodiment the present disclosure provides a method for removing material collected in pockets evenly space about an inner surface of an indent cylinder. The method comprises rotatably mounting a hub on a working end of a shaft; providing a plurality of spikes extending from a surface of the hub, wherein the spikes extend radially outward from a rotational axis of the hub substantially the same distance; spacing the outer ends of the spikes to correspond to a spacing of the pockets of the indent cylinder; inserting the hub into an interior of the indent cylinder and holding a handle end of the shaft substantially parallel to a rotational axis of the indent cylinder and rotating the indent cylinder and pressing the hub toward the inner surface of the indent cylinder such that the pointed outer ends of the spikes enter the pockets as the indent cylinder rotates and dislodge the material from the pockets.

The present disclosure thus provides a cleaning apparatus for more conveniently removing material collected in the pockets of an indent cylinder, reducing the necessity of disassembling the grain cleaner to get access to clean the pockets. The pointed outer ends of the spikes are spaced to accommodate different sizes and spacings of pockets such as are found on different indent cylinders, and the shaft length can be adjusted to allow working in confined areas as is common in grain cleaning plants where such indent cylinders are commonly used.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic perspective end view of an indent cylinder with an embodiment of a cleaning apparatus of the present disclosure adjacent to an open end of the indent cylinder;

FIG. 2 is a schematic sectional view of an indent cylinder as same would be installed in a grain cleaning machine, and showing the embodiment of the cleaning apparatus of FIG. 1 in operation pressed against the top inner surface of the indent cylinder;

FIG. 3 is a schematic end view of the embodiment of the cleaning apparatus of FIG. 1;

FIG. 4 is a schematic side view of the embodiment of the cleaning apparatus of FIG. 1;

FIG. 5 is schematic illustration of the pattern of pockets on an indent cylinder showing the path of the pointed ends of the spikes of the cleaning apparatus of FIG. 1;

FIG. 6 is schematic illustration of the pattern of the pointed ends of the spikes of the cleaning apparatus of FIG. 1;

FIG. 7 is a schematic end view of the embodiment of the cleaning apparatus of FIG. 1 with a larger diameter hub installed on the shaft;

FIG. 8 is schematic illustration of the pattern of pockets on a different indent cylinder showing the path of the pointed ends of the spikes on the larger hub of FIG. 7;

FIG. 9 is a schematic side view of a shaft of the present disclosure where the length thereof is adjusted by telescoping the shaft;

FIG. 10 is a schematic side view of a shaft of the present disclosure where the length thereof is adjusted by adding or removing sections;

FIG. 11 is schematic sectional side view showing the pointed end of a spike in a pocket of an indent cylinder.

### DETAILED DESCRIPTION OF THE ILLUSTRATED EMBODIMENTS

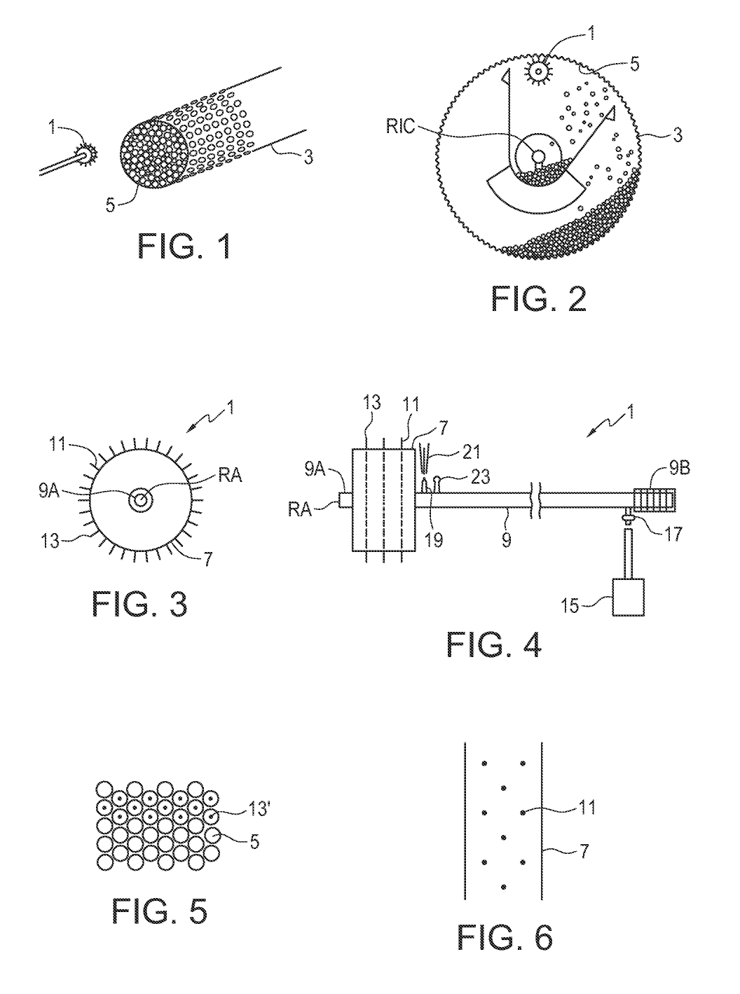

FIGS. 1-4 schematically illustrate an embodiment of a cleaning apparatus 1 of the present disclosure for removing material collected in the pockets 5 of an indent cylinder 3. The indent cylinder 3 comprises a hollow metal tube with a plurality of pockets 5 evenly spaced about the inner surface of the tube. Typically, as illustrated, the tube has a thin wall and the pockets 5 which are recessed into the inner surface extend outward from the outer surface of the tube.

The apparatus 1 comprises a hub 7 rotatably mounted on a shaft 9 near a working end 9A of the shaft. A plurality of spikes 11 extend from the surface of the hub 7. The outer ends 13 of the spikes 11 are typically pointed, especially in indent cylinders 3 where the pockets 5 are relatively small, and the spikes 11 extend radially outward from a rotational axis RA of the hub 7 the same distance. The outer ends 13 of the spikes 11 are evenly spaced to correspond to a spacing of the pockets 5 of the indent cylinder 3 as seen in FIG. 5.

The apparatus 1, as schematically illustrated in FIG. 6, has a pattern along the periphery of the hub 7 that has three rows of spikes 11, with the spikes 11 on the inside row offset between the spikes 11 on the outside rows to match the pattern of the pockets 5 of the indent cylinder as schematically illustrated in FIG. 5. In operation the operator, holding the handle end 9B of the shaft 9, opposite the working end 9A thereof, inserts the apparatus 1 into the interior of the indent cylinder 3 and presses the hub 7 toward the inner surface of the indent cylinder 3 as shown in FIG. 2 such that the pointed outer ends 13 of the spikes 11 enter the pockets 5 as the indent cylinder 3 rotates.

The outer ends 13 of the spikes 11 enter the pockets 5 in the path schematically illustrated in FIG. 5 as the indent cylinder rotates and the spikes 11 dislodge the material that is stuck in the pockets 3. It can be seen that the outer end 13 of one of the spikes enters each of the pockets 5 in the path. As complete rotations of the indent cylinder occur the operator, essentially going by feel, manipulates the handle end 9B of the shaft to move the hub 7 and spikes 11 along the length of the indent cylinder 3 to an adjacent path for another complete revolution, and so on. It is contemplated that a wider hub could be used with more rows of spikes 11 to cover a wider path however proper orientation of the hub 7 may be more difficult with a wider hub.

In the illustrated apparatus 1 the shaft 9 is hollow and adapted at the handle end 9B thereof for connection to a source of pressurized air 15 through a quick connect air chuck 17. An air nozzle 19 is connected to an interior of the shaft 9 adjacent to the hub 7, and is configured to direct an air stream 21 outward from the shaft 9 to blow material out of the pockets 5. A direction indicator on the handle end 9B of the shaft 9 conveniently indicates the direction of the air stream 21 so the operator can rotate the shaft if necessary to correctly orient the air stream 21 toward the inner surface of the indent cylinder 3 where the spikes 11 are entering the pockets 5. Conveniently in the illustrated apparatus 1 the direction indicator is provided by orienting the air chuck 17 radially outward from the shaft 9 in a direction 180 degrees around the shaft 9 from the direction of the air stream 21.

It is contemplated that in most grain cleaning machines the best access to the interior of the indent cylinders 3 for cleaning the pockets 5 will be in the top area as shown by the apparatus 1 working against the top of the indent cylinder 3 as seen in FIG. 2. An air hose connected to the air chuck 17 will thus hang down, and not place any twisting torque on the handle end 9B of the shaft 9 which could rotate the shaft so the air stream 21 is not directed at the adjacent pockets 5.

The apparatus 1 further comprises a light 23 attached to the shaft adjacent to the hub 7 on a handle side of the hub 7 oriented to direct a light beam substantially radially outward from the shaft in a light direction substantially in the same direction as the direction of air stream 21.

Conveniently the length of the shaft 9 is adjustable by telescoping the shaft 9′ as schematically illustrated in FIG. 9, or by and adding or removing shaft sections 9C′ connected by couplers 25 as schematically illustrated in FIG. 10 to vary then length of the handle 9″.

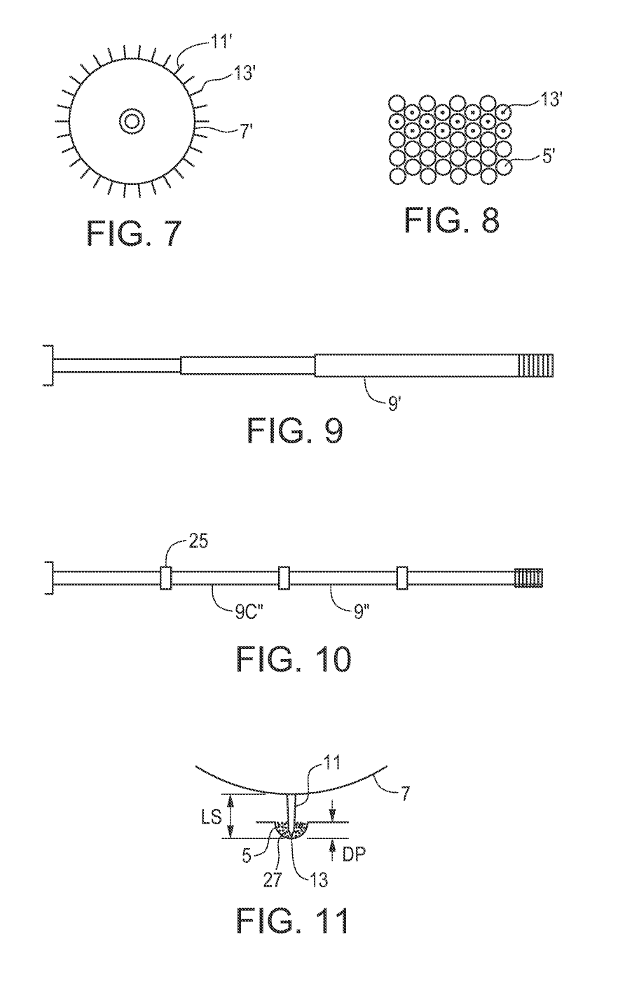

The size and spacing of the pockets 5 on the inner surface of various indent cylinders will vary, depending on the material being separated, such that a variety of hubs 7 with different spike patterns will be required to clean a corresponding variety of different pocket patterns. To facilitate this, in the apparatus 1 the hub 7 is removably mounted on the shaft 9. Thus a first hub 7 with the outer ends 13 of the spikes 11 thereof evenly spaced to correspond to a first spacing of the pockets 5 of a first indent cylinder, such as shown in FIG. 5 can be removed and replaced on the shaft with a second hub 7′ as shown in FIG. 7 with the outer ends 13′ of the spikes 11′ thereof evenly spaced to correspond to a second spacing of the pockets 5′ of a second indent cylinder as shown in FIG. 8. The outer ends 13′ of the spikes 11′ enter the pockets 5′ in the path schematically illustrated in FIG. 8 as the indent cylinder rotates.

As schematically illustrated in greater detail in FIG. 11, the illustrated hub 7 is cylindrical and the spikes 11 extend a spike length SL from the surface of the hub 7, and the spike length SL is greater than a depth DP of the pockets 5 to allow the pointed end 13 of the spike 11 to reach the bottom of the pockets 5 and dislodge any material 27 that is stuck in the pockets 5. The longer the spike length SL, the more likely the spikes 11 are to bend. It is contemplated that the spike length SL will generally be about twice or more the depth DP of the pockets 5 in order to reduce the risk of the spikes 11 bending, but still leave sufficient clearance between the outer surface of the hub 7 and the inner surface of the indent cylinder to allow dislodged material to fall away.

The diameter of the hub 7′ is proportionally larger than that of the hub 7 as the size and spacing of the pockets 5′ is somewhat greater than that of the pockets 5. If the diameter was the same the spike length SL would need to be longer and so the larger diameter allows for the spikes 11 to be shorter, and thus less liable to bend.

The present disclosure provides a method for removing material 27 collected in pockets 5 evenly space about an inner surface of an indent cylinder 3. The method comprises rotatably mounting a hub 7 on a working end 9A of a shaft 9; providing a plurality of spikes 11 extending from a surface of the hub 7, wherein outer ends 13 of the spikes 11 are pointed and the spikes 11 extend radially outward from a rotational axis RA of the hub 7 substantially the same distance; spacing the outer ends 13 of the spikes 11 to correspond to a spacing of the pockets 5 of the indent cylinder 3; inserting the hub 7 into an interior of the indent cylinder 3 and holding a handle end 9B of the shaft 9 substantially parallel to a rotational axis RIC of the indent cylinder, and rotating the indent cylinder 3 and pressing the hub 7 toward the inner surface of the indent cylinder 3 such that the pointed outer ends 13 of the spikes 11 enter the pockets 5 as the indent cylinder 3 rotates and dislodge the material 27 from the pockets 5. The operator manipulates the handle end 9B to move the hub along substantially a length of the indent cylinder 3.

Where maneuvering room is limited, the operator can adjust a length of the shaft 9 to allow the hub 7 to be moved along the length of the indent cylinder 3. To blow out dislodged material the method further comprises mounting an air nozzle 19 on the shaft 9 adjacent to the hub 7, and directing a pressurized air stream 21 through the nozzle 19 radially outward from the shaft 9 and into the pockets 5.

To accommodate cleaning material from a variety of indent cylinders 3 with different sizes and spacings of pockets 5, such as material collected in pockets 5 of first and second indent cylinders with corresponding first and second pocket 5, 5′ spacings that are unequal, the method comprises removably attaching a first hub 7 with the outer ends 13 of the spikes 11 thereof evenly spaced to correspond to the first spacing to remove material from the pockets 5 of the first indent cylinder, then removing the first hub 7 and removably attaching a second hub 7′ with the outer ends 13′ of the spikes 11′ thereof evenly spaced to correspond to the second spacing to remove material from the pockets 5′ of the second indent cylinder. Any number of hubs may be provided to allow cleaning of a similar number of indent cylinders.

The cleaning apparatus 1 conveniently removes material collected in the pockets 5 of an indent cylinder 3. The pointed outer ends 13 of the spikes 11 are spaced to accommodate different sizes and spacings of pockets 5, and the shaft length can be adjusted to allow working in confined areas as is common in grain cleaning plants where such indent cylinders are commonly used.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A cleaning apparatus for removing material collected in pockets evenly space about an inner surface of an indent cylinder, the apparatus comprising:
a hub rotatably mounted on a shaft near a working end of the shaft;
a plurality of spikes extending from a surface of the hub, wherein the spikes extend radially outward from a rotational axis of the hub substantially the same distance; and
wherein the outer ends of the spikes are evenly spaced to correspond to a spacing of the pockets of the indent cylinder.

2. The apparatus of claim 1 wherein the shaft is hollow and adapted at a handle end thereof, opposite the working end thereof, for connection to a source of pressurized air, and comprising an air nozzle connected to an interior of the shaft adjacent to the hub, the nozzle configured to direct an air stream outward from the shaft.

3. The apparatus of claim 2 comprising a direction indicator on the handle end of the shaft indicating the direction of the air stream.

4. The apparatus of claim 3 wherein the handle end of the shaft is adapted for connection to the source of pressurized air by a quick connect air chuck extending laterally from the shaft, and where the direction indicator is provided by orienting the air chuck radially outward from the shaft in a direction 180 degrees around the shaft from the direction of the air stream.

5. The apparatus of claim 2 comprising a light attached to the shaft adjacent to the hub on a handle side of the hub and oriented to direct a light beam substantially radially outward from the shaft in a light direction.

6. The apparatus of claim 5 wherein the light direction is substantially the same direction as the direction of the air stream.

7. The apparatus of claim 1 wherein a length of the shaft is adjustable.

8. The apparatus of claim 7 wherein the length of the shaft is adjustable by one of telescoping the shaft and adding or removing shaft sections.

9. The apparatus of claim 1 wherein the hub is removably mounted on the shaft.

10. The apparatus of claim 9 comprising a first hub with the outer ends of the spikes thereof evenly spaced to correspond to a first spacing of the pockets of a first indent cylinder, and a second hub with the outer ends of the spikes thereof evenly spaced to correspond to a second spacing of the pockets of a second indent cylinder.

11. The apparatus of claim 1 wherein the hub is cylindrical and the spikes extend a spike length from the surface of the hub, and wherein the spike length is greater than a depth of the pockets.

12. The apparatus of claim 11 wherein the spike length is greater than about twice the depth of the pockets.

13. The apparatus of claim 1 wherein the outer ends of the spikes are pointed.

14. A method for removing material collected in pockets evenly space about an inner surface of an indent cylinder, the method comprising:
rotatably mounting a hub on a working end of a shaft;
providing a plurality of spikes extending from a surface of the hub, wherein the spikes extend radially outward from a rotational axis of the hub substantially the same distance;
spacing the outer ends of the spikes to correspond to a spacing of the pockets of the indent cylinder;
inserting the hub into an interior of the indent cylinder and holding a handle end of the shaft substantially parallel to a rotational axis of the indent cylinder; and
rotating the indent cylinder and pressing the hub toward the inner surface of the indent cylinder such that the pointed outer ends of the spikes enter the pockets as the indent cylinder rotates and dislodge the material from the pockets.

15. The method of claim 14 comprising manipulating the handle end of the shaft to move the hub along substantially a length of the indent cylinder.

16. The method of claim 15 comprising, where maneuvering room is limited, adjusting a length of the shaft to allow the hub to be moved along the length of the indent cylinder.

17. The method of claim 14 comprising mounting an air nozzle on the shaft adjacent to the hub, and directing a pressurized air stream through the nozzle radially outward from the shaft and into the pockets to blow dislodged material out of the pockets.

18. The method of claim 14 for removing material collected in pockets of first and second indent cylinders with corresponding first and second pocket spacings that are unequal, the method comprising:
removably attaching a first hub with the outer ends of the spikes thereof evenly spaced to correspond to the first spacing to remove material from the pockets of the first indent cylinder;
removing the first hub and removably attaching a second hub with the outer ends of the spikes thereof evenly spaced to correspond to the second spacing to remove material from the pockets of the second indent cylinder.

19. The method of claim 14 wherein the hub is cylindrical and the spikes extend a spike length from the surface of the hub, and wherein the spike length is greater than a depth of the pockets.

20. The method of claim 19 wherein the spike length is greater than about twice the depth of the pockets.

21. The method of claim 14 wherein the outer ends of the spikes are pointed.
